(19) United States
(12) Patent Application Publication
(10) Pub. No.: US 2007/0289121 A1
(43) Pub. Date: Dec. 20, 2007

(54) Method for setting stator coil, and method for manufacturing rotating electrical machine

(76) Inventor: Kazuyuki Yamaguchi, Kariya-shi (JP)

Correspondence Address: MORGAN & FINNEGAN, L.L.P., 3 World Financial Center, New York, NY, 10281-2101, US

(21) Appl. No.: 11/818,633

(22) Filed: Jun. 15, 2007

(30) Foreign Application Priority Data
Jun. 15, 2006 (JP) 2006-166487

(51) Int. Cl. H02K 1/12

(52) U.S. Cl. 29/596; 310/258; 29/598

(57) ABSTRACT

A pair of second retaining groups sandwiching the first retaining group. The length of the second coil retainers differ from the length of first coil retainers. The first coil retainers and the second coil retainers are arranged on a same line. The pair of second retaining groups are displaced from each other in the longitudinal direction of the second coil retainers. The stator coils on the coil holder are set along a predetermined direction. At least part of the stator coils overlap one another. The second coil retainers of one of the second retaining group are connected to the second coil retainers of the other second retaining group with respect to the longitudinal direction of the second coil retainers, while the coil retainers are arranged in an annular shape at equal intervals. Therefore, stator coils are evenly arranged.

### BACKGROUND OF THE INVENTION

The present invention relates to a method for setting stator coils on a blade of an inserter. Furthermore, the present invention pertains to a method for manufacturing a rotating electrical machine including a stator core about which stator coils are wound.

A stator used for a rotating electrical machine such as an electric motor and a generator has a stator core including teeth. Stator coils are inserted in slots formed between the teeth. Japanese Patent No. 3448204, Japanese Patent No. 3673330, Japanese Patent No. 3673337, and Japanese Laid-Open Patent Publication No. 2005-184887 disclose methods for winding stator coils. In these methods, the stator coils are wound around a stator core such that each stator coil extends over a number of teeth. The stator coils overlap one another to form a spiral shape as a whole.

Japanese Laid-Open Patent Publication No. 2005-80356 discloses a method for inserting stator coils in slots of a stator core using an inserter.

In a case where the stator coils are inserted in the slots of the stator core using the inserter, the stator coils that are formed into a predetermined shape in advance need to be set on a blade of the inserter. In order to apply the above inserter to the methods disclosed in Japanese Patent No. 3448204, Japanese Patent No. 3673330, Japanese Patent No. 3673337, and Japanese Laid-Open Patent Publication No. 2005-184887, it is necessary to set, on the blade, the stator coils that are formed into a shape that permits the stator coils to overlap one another to form a spiral shape when inserted in the slots of the stator.

However, in the conventional methods, since the stator coils are manually arranged on the blade, the arrangement of the stator coils inserted in the slots tends to be uneven. In particular, unevenness in the arrangement is significant at the region where the stator coil that is set on the blade first overlaps the stator coil that is set on the blade last. The uneven arrangement of the stator coils reduces the efficiency of the rotating electrical machine.

Furthermore, the above-mentioned Japanese Patent No. 3673330, Japanese Patent No. 3673337, and Japanese Laid-Open Patent Publication No. 2005-184887 disclose methods for manufacturing a single stator core by combining divided cores. More specifically, the stator core is manufactured by setting the stator coils, which are formed into a predetermined shape, on the divided cores in advance, and thereafter combining the divided cores. In this case, the inserter need not be used. However, the stator core manufactured by combining the divided cores reduces the efficiency of the rotating electrical machine as compared to an integrated stator core.

Accordingly, it is an objective of the present invention to evenly arrange stator coils when the stator coils are mounted on a stator core using an inserter in a state where the stator coils overlap one another to form a spiral shape.

### SUMMARY OF THE INVENTION

According to one aspect of the invention, a method for setting a plurality of stator coils on an inserting blade before mounting the stator coils on a stator core using the inserting blade such that the stator coils overlap one another to form a spiral shape is provided. The method includes preparing a coil holder. The coil holder includes a first retaining group and a pair of second retaining groups sandwiching the first retaining group. The first retaining group includes a plurality of rod-like first coil retainers. The pair of second retaining groups each includes the same number of second coil retainers. The length of the second coil retainers differ from the length of the first coil retainers. The first coil retainers and the second coil retainers are arranged on a same line. The pair of second retaining groups are displaced from each other in the longitudinal direction of the second coil retainers. The method further includes sequentially setting the stator coils on the coil holder along a predetermined direction. Each stator coil is set on two of the coil retainers that are separate from each other so as to sandwich a predetermined number of the coil retainers. The stator coils are inclined with respect to the coil retainers. At least part of the stator coils overlap one another. The method further includes connecting the second coil retainers of one of the second retaining group to the second coil retainers of the other second retaining group with respect to the longitudinal direction of the second coil retainers, while arranging the coil retainers in an annular shape at equal intervals. The method further includes setting the stator coils on the inserting blade.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a perspective view illustrating a stator manufactured by a method according to a first embodiment of the present invention, and the stator includes a stator core around which stator coils are wound;

FIG. 2 is a perspective view illustrating a base on which a setting jig is arranged;

FIG. 3 is a perspective view illustrating a state where a single stator coil is set on the setting jig of FIG. 2;

FIG. 4 is a perspective view illustrating a state where all the stator coils are set on the setting jig of FIG. 3;

FIG. 5 is a perspective view illustrating a state where half or more of the retaining members shown in FIG. 4 are arranged on an annular line;

FIG. 6 is a perspective view illustrating a state where all the retaining members shown in FIG. 5 are arranged on the annular line;

FIG. 7 is a perspective view illustrating a state where all the stator coils shown in FIG. 6 are moved from the setting jig to an inserting blade;

FIG. 8 is a schematic diagram illustrating a state where the second retaining members shown in FIG. 2 are placed on a retaining base;

FIG. 9 is a schematic diagram illustrating a state where the second retaining members shown in FIG. 8 are clamped by a clamping device; and

FIG. 10 is a perspective view illustrating a state where all the stator coils are set on a setting jig according to a second embodiment of the present invention.

### DESCRIPTION OF THE PREFERRED EMBODIMENTS

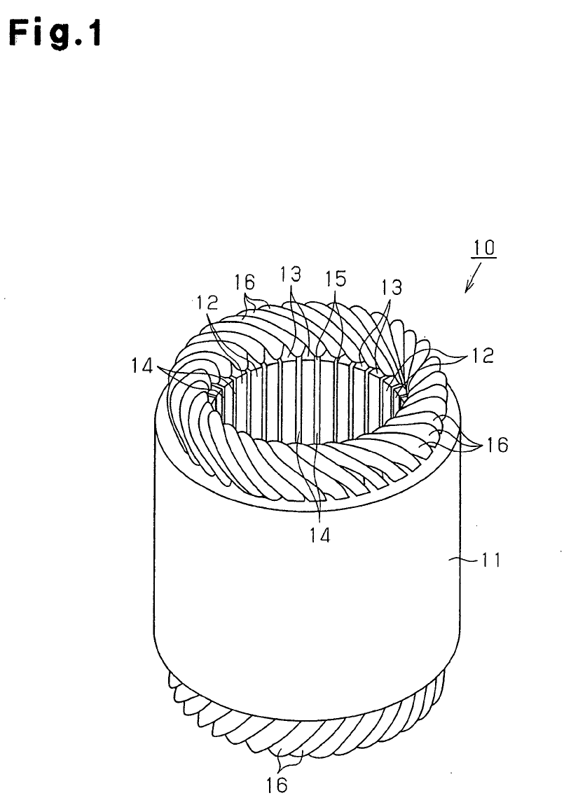

A first embodiment of the present invention will now be described with reference to FIGS. 1 to 9.

FIG. 1 shows a stator 10 used in a rotating electrical machine such as an electric motor and a generator. Teeth 12, which project radially inward, are formed on the inner circumferential portion of a stator core 11. The teeth 12 are arranged at equal pitches in the circumferential direction. The stator core 11 of the first embodiment is an integral part, and is not manufactured by combining divided cores. The teeth 12 are T-shaped as viewed from the axial direction. A radially inner end of each tooth 12 has a pair of protrusions 13, which protrude in both circumferential directions. Slots 14 are formed between the teeth 12. The slots 14 extend in the axial direction of the stator core 11. An opening portion 15 of each slot 14 is defined between a pair of adjacent protrusions 13.

Stator coils 16 are mounted on the stator core 11. Each stator coil 16 is formed by a conductive wire wound into an annular shape. Each stator coil 16 is mounted on the stator core 11 so as to extend over a predetermined number of the teeth 12. Each stator coil 16 includes an inner section, which extends along a radially inward section of the stator core 11, and an outer section, which extends along a radially outward section of the stator core 11. The inner section of each stator coil 16 is arranged in the vicinity of the opening portion 15 of the corresponding slot 14. The outer section of each stator coil 16 is arranged at the inner most portion of the corresponding slot 14. Each stator coil 16 bulges from the inner section toward the outer section. The adjacent stator coils 16 closely contact each other. Thus, the stator coils 16 are mounted on the stator core 11 such that the stator coils 16 overlap one another to form a spiral shape as a whole.

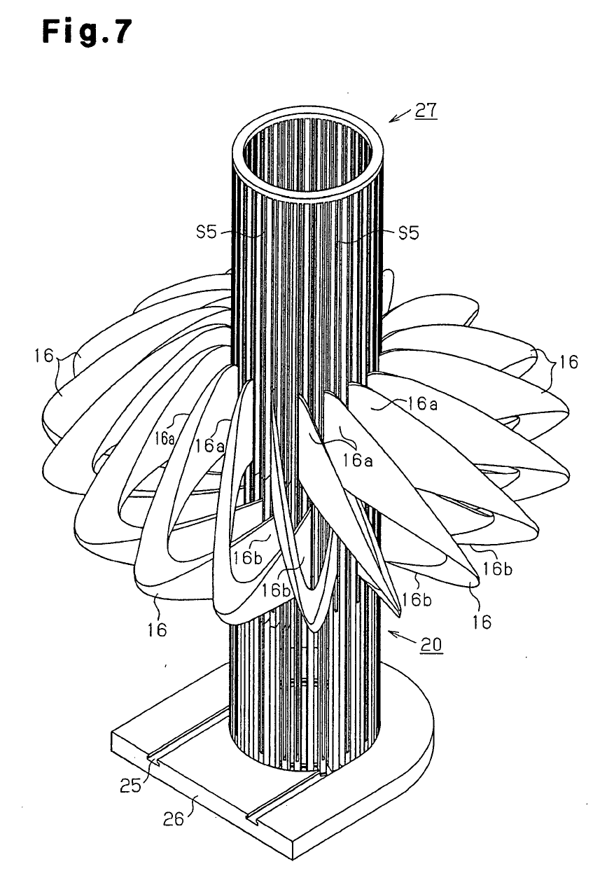

The stator coils 16 are inserted in the slots 14 of the stator core 11 using an inserter so as to be mounted on the stator core 11. The stator coils 16 are set on an inserting blade 27 (shown in FIG. 7) of the inserter, and are inserted in the stator core 11 via the inserting blade 27.

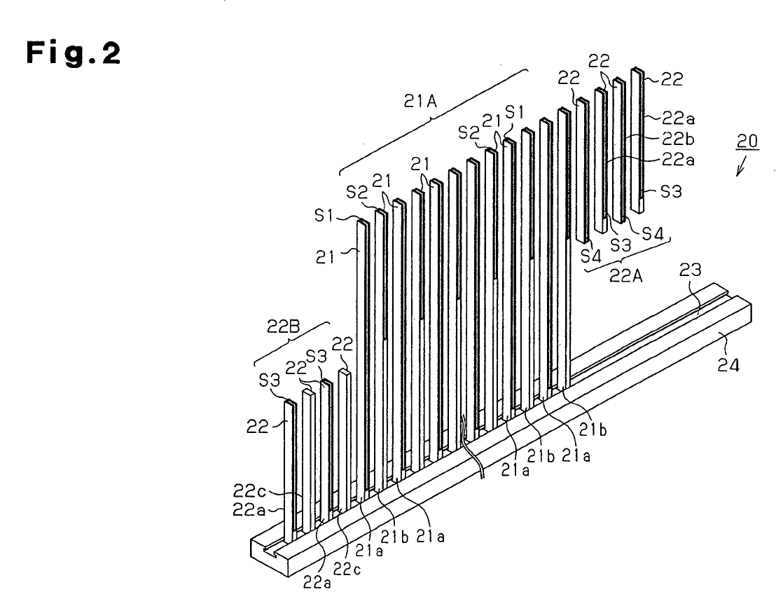

FIGS. 2 to 6 show a procedure for setting the stator coils 16 on a coil holder, which is a setting jig 20 in the first embodiment. The stator coils 16 are set on a coil setting jig, which is the setting jig 20 in the first embodiment, such that the stator coils 16 overlap one another to form a spiral shape. FIG. 7 shows a manner in which the stator coils 16, which overlap one another to form a spiral shape, are moved from the setting jig 20 to the inserting blade 27 while maintaining the spiral shape.

The setting jig 20 includes independent first coil retainers, which are first retaining members 21 in the first embodiment, and independent second coil retainers, which are second retaining members 22 in the first embodiment. The number of the first retaining members 21 and the number of the second retaining members 22 are determined in accordance with the specification of the electric motor and the rotary machine. That is, the number of the first retaining members 21 and the number of the second retaining members 22 are determined in accordance with the number of the slots 14 and the number of the teeth 12 over which each stator coil 16 extends. Each stator coil 16 is inserted in two slots 14. The number of the first retaining members 21 and the number of the second retaining members 22 are determined in accordance with the distance between two slots 14 in which each stator coil 16 is inserted.

The first retaining members 21 and the second retaining members 22 all have a rod-like shape, that is, a square columnar shape. The length of the first retaining members 21 differs from the length of the second retaining members 22. The length of the second retaining members 22 of the first embodiment is set to half the length of the first retaining members 21. That is, the length of the two second retaining members 22 connected to each other is the same as the length of the first retaining member 21. FIG. 2 shows a manner in which the first retaining members 21 and the second retaining members 22 extend in the vertical direction. However, the first retaining members 21 and the second retaining members 22 need not extend in the vertical direction, and may extend in the left and right direction.

As shown in FIG. 2, the first retaining members 21 and the second retaining members 22 are arranged on a straight first base 24. The first base 24 includes a straight groove 23 having a T-shaped cross-section. The proximal end of each first retaining member 21 (lower end in FIG. 2) and the proximal end of each second retaining member 22 are T-shaped, and are inserted in the straight groove 23. As a result, all the first retaining members 21 and all the second retaining members 22 are arranged on the same straight line. All the first retaining members 21 and all the second retaining members 22 are arranged on the first base 24 at equal intervals. The first retaining members 21 and the second retaining members 22 extend perpendicular to the first base 24. The first retaining members 21 and the second retaining members 22 are selectively separated from the first base 24.

All the first retaining members 21 are arranged on the first base 24 together, and configure a first retaining group, which is a main retaining group 21A in the first embodiment. The term first retaining members 21 is a collective term for first long bars 21a, each of which includes a first slit S1, and second long bars 21b, each of which includes a second slit S2. The second slits S2 are shorter than the first slits S1. The length of the first long bars 21a is equal to the length of the second long bars 21b. The first long bars 21a and the second long bars 21b of the main retaining group 21A are arranged alternately at equal intervals. The number of the first long bars 21a is equal to the number of the second long bars 21b. The first slits S1 extend along almost the entire length of the first long bars 21a. The length of the second slits S2 is approximately half the length of the first slits S1. The stator coils 16 are inserted in and supported by the first slits S1 and the second slits S2. The first slits S1 are open at the distal ends of the first long bars 21a (upper ends in FIG. 2), and the second slits S2 are open at the distal ends of the second long bars 21b.

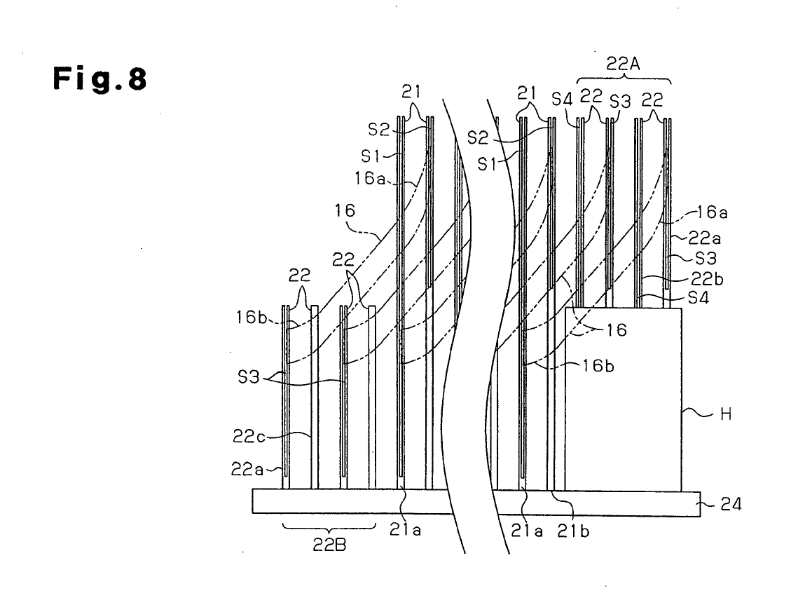

The second retaining members 22 are divided into an upper retaining group 22A and a lower retaining group 22B. The upper retaining group 22A and the lower retaining group 22B are second retaining groups. The main retaining group 21A is located between the upper retaining group 22A and the lower retaining group 22B. The upper retaining group 22A and the lower retaining group 22B are displaced from each other in the axial direction of the second retaining members 22, that is, in the vertical direction in FIG. 2. The upper retaining group 22A is arranged at the back in FIG. 2, and the lower retaining group 22B is arranged at the front in FIG. 2. As shown in FIG. 8, the upper retaining group 22A is arranged on a retaining base H on the first base 24. The number of the second retaining members 22 of the upper retaining group 22A is equal to the number of the second retaining members 22 of the lower retaining group 22B. The number of the second retaining members 22 of the upper and lower retaining groups 22A, 22B is four in the first embodiment.

As shown in FIG. 2, the term second retaining members 22 is a collective term for first short bars 22a, each of which includes a third slit S3, second short bars 22b, each of which includes a fourth slit S4, and third short bars 22c, each of which does not include a slit. Dividing one of the first long bars 21a into two forms the first short bar 22a and the second short bar 22b. Dividing one of the second long bars 21b into two forms the first short bar 22a and the third short bar 22c. The upper retaining group 22A is configured by the first short bars 22a and the second short bars 22b. The lower retaining group 22B is configured by the first short bars 22a and the third short bars 22c.

The length of the first short bars 22a is equal to the length of the second short bars 22b. The length of the third slits S3 is equal to the length of the second slits S2, and the third slits S3 extend along the most part of the first short bars 22a. The third slits S3 are open at the distal ends of the first short bars 22a. The fourth slits S4 are longer than the third slits S3, and extend along the entire length of the second short bars 22b. The fourth slits S4 are open at the distal ends and the proximal ends of the second short bars 22b. Dividing one of the first slits S1 into two forms the third slit S3 and the fourth slit S4. The stator coils 16 are inserted in and supported by the third slits S3 and the fourth slits S4. The first short bars 22a and the second short bars 22b are alternately arranged at equal intervals.

The first short bars 22a and the third short bars 22c of the lower retaining group 22B are alternately arranged at equal intervals. The first retaining members 21 and the second retaining members 22 are arranged such that all the first to fourth slits S1 to S4 are open to one direction, that is, upward in FIG. 2. The first base 24 supports the first retaining members 21 and the second retaining members 22, and functions as a rail for guiding the movement of the retaining members 21, 22.

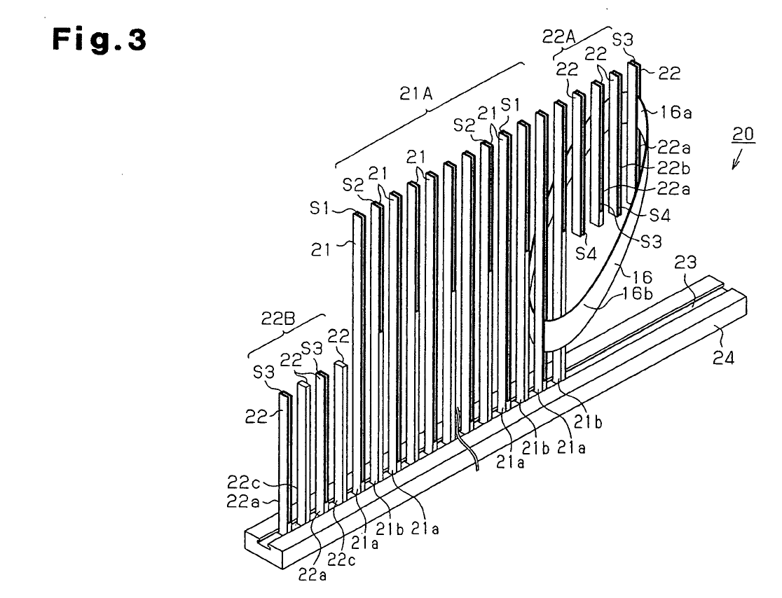

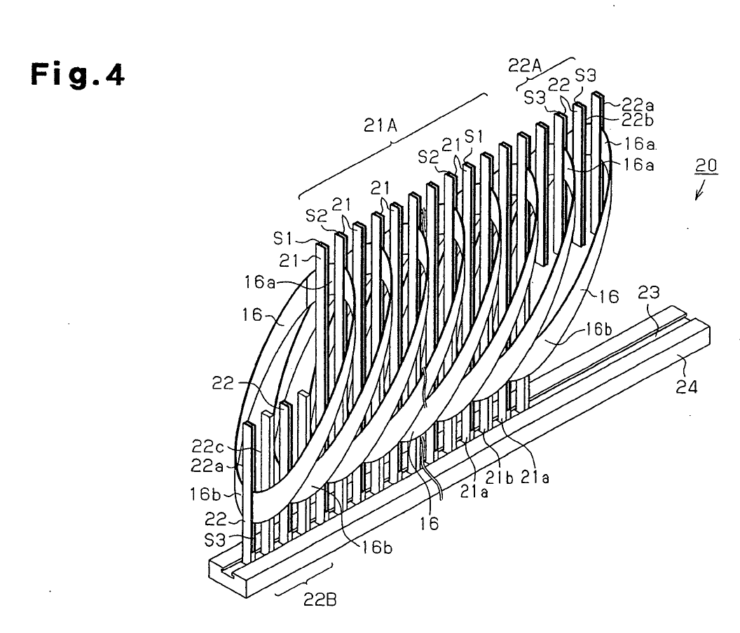

FIG. 3 shows a state where a single stator coil 16 is set on the setting jig 20. FIG. 4 shows a state where all the stator coils 16 are set on the setting jig 20. As shown in FIGS. 3 and 4, the stator coils 16 are set on the first retaining members 21 and the second retaining members 22 on the first base 24. Each stator coil 16 includes a first section 16a, which is inserted in one of the second slits S2 or one of the third slits S3 of the upper retaining group 22A, and a second section 16b, which is inserted in one of the first slits S1 or one of the third slits S3 of the lower retaining group 22B. That is, the depth to which each second section 16b is inserted in the first slit S1 is greater than the depth to which the first section 16a is inserted in the second slit S2 or the third slit S3 of the upper retaining group 22A. The second slit S2 or the third slit S3 of the upper retaining group 22A into which the first section 16a of each stator coil 16 is inserted is apart from the first slit S1 or the third slit S3 of the lower retaining group 22B into which the second section 16b of the same stator coil 16 is inserted by a predetermined number of the arrangement pitches of the slits S1 to S4. That is, each stator coil 16 is set on a pair of the retaining members 21, 22 between which a predetermined number of the retaining members 21, 22 are located.

In the first embodiment, four retaining members 21, 22 are located between the second retaining member 22 of the first retaining member 21 having the second slit S2 on which the first section 16a of each stator coil 16 is set, and the first retaining member 21 having the first slit S1 or the first short bar 22a of the lower retaining group 22B on which the second section 16b of the same stator coil 16 is set. Thus, the first section 16a of each stator coil 16 is displaced from the second section 16b by five arrangement pitches of the slits S1 to S4.

The arrangement pitch of the slits S1 to S4 correlates with the arrangement pitch of the teeth 12 of the stator core 11. More specifically, the arrangement pitch of the first slits S1 corresponds to the arrangement pitch of the teeth 12. The distance between one of the first slits S1 and the adjacent second slit S2 corresponds to half the arrangement pitch of the teeth 12. The interval between the first section 16a and the second section 16b of each stator coil 16 on the setting jig 20 is determined in accordance with the number of the teeth 12 over which the stator coil 16 will extend. The distance between the second slit S2 or the third slit S3 of the upper retaining group 22A into which the first section 16a of each stator coil 16 is inserted and the first slit S1 or the third slit S3 of the lower retaining group 22B into which the second section 16b of the same stator coil 16 is inserted is determined in accordance with the specification of the electric motor or the rotary machine. The interval between the first section 16a and the associated second section 16b is also determined in accordance with the number of the stator coils 16 that overlap any of the stator coils 16.

The first sections 16a and the second sections 16b of the stator coils 16 are inserted in the slits S1 to S4 so as to be displaced in the vertical direction. That is, the stator coils 16 are set on the first retaining members 21 and the second retaining members 22 in an inclined state.

The first section 16a of the stator coil 16 shown in FIG. 3 is set on one of the second retaining members 22 of the upper retaining group 22A located at the back of FIG. 3, and the second section 16b of this stator coil 16 is set on one of the first retaining members 21 that is located forward of the first section 16a. One of the first retaining members 21 and three of the second retaining members 22 of the upper retaining group 22A are located between the first section 16a and the second section 16b. As shown in FIG. 4, all the stator coils 16 are sequentially set on the setting jig 20 with predetermined intervals provided between one another. All the stator coils 16 are set toward a predetermined direction, more specifically, from the upper retaining group 22A toward the lower retaining group 22B. The second section 16b of each stator coil 16 is overlapped by the first section 16a of the stator coil 16 that is subsequently set on the setting jig 20. The second section 16b of the stator coil 16 that has the first section 16a that is set on the upper retaining group 22A is set on the main retaining group 21A. The first section 16a of the stator coil 16 that has the second section 16b that is set on the lower retaining group 22B is set on the main retaining group 21A. In this manner, all the stator coils 16 are sequentially set on the setting jig 20 from the back to the front in FIG. 4. All the stator coils 16 set on the setting jig 20 are inclined with respect to the first retaining members 21 and the second retaining members 22, and the adjacent stator coils 16 partially overlap each other.

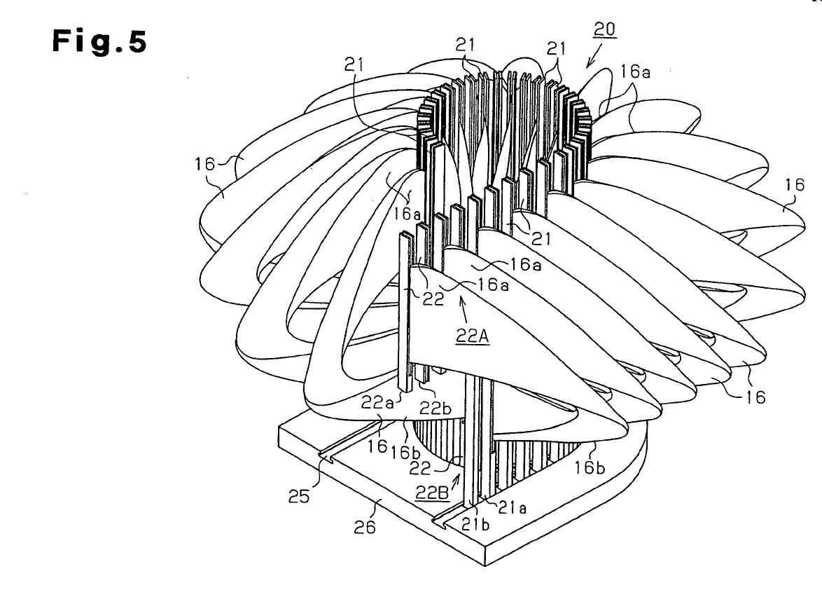

Subsequently, the first retaining members 21 and the second retaining members 22 on which the stator coils 16 are set are arranged on a second base 26 at equal intervals as shown in FIG. 5. An annular shape forming groove 25, which includes an annular groove, is formed in the second base 26. All the first retaining members 21 and the second retaining members 22 of the lower retaining group 22B are inserted in the annular shape forming groove 25, and are arranged in an annular shape. The second retaining members 22 of the upper retaining group 22A are connected to the second retaining members 22 of the lower retaining group 22B, thereby forming retaining members equivalent to the first retaining members 21. More specifically, connecting the first short bars 22a of the upper retaining group 22A to the third short bars 22c of the lower retaining group 22B forms the second long bars 21b. Connecting the fourth slits S4 to the third slits S3 forms the first slits S1. Connecting the second short bars 22b of the upper retaining group 22A to the first short bars 22a of the lower retaining group 22B forms the first long bars 21a.

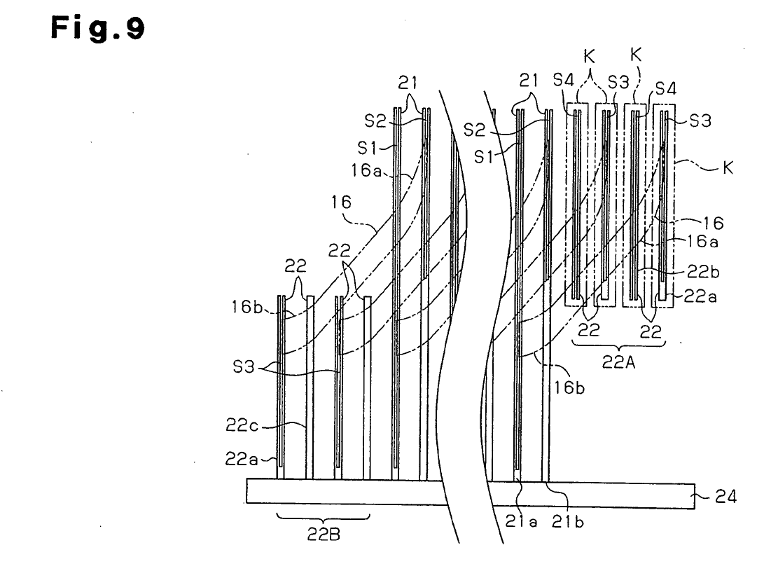

In this manner, all the first retaining members 21 and all the second retaining members 22 are arranged on an annular line. A clamping device K shown in FIG. 9 clamps the second retaining members 22 of the upper retaining group 22A, and arranges them on the second base 26. Since each second retaining member 22 is clamped independently, the second retaining members 22 are easily arranged in an annular shape. The straight groove 23 of the first base 24 may be connected to the annular shape forming groove 25 of the second base 26 so as to directly move all the first retaining members 21 and the second retaining members 22 from the straight groove 23 in FIG. 4 to the annular shape forming groove 25 in FIG. 5. Furthermore, all the first retaining members 21 and the second retaining members 22 may be removed from the first base 24 shown in FIG. 4 and moved to the second base 26 of FIG. 5 by a transfer equipment to be arranged in an annular shape.

In this manner, by setting the stator coils 16 on the second retaining members 22, which are divided into the upper section and the lower section, and thereafter connecting the second retaining members 22, the stator coils 16 retained by the lower retaining group 22B can be arranged below the stator coils 16 retained by the upper retaining group 22A. That is, the stator coils 16 set on the upper retaining group 22A can be arranged to overlap the stator coils 16 set on the lower retaining group 22B to form a spiral shape.

The stator coils 16 set on the upper retaining group 22A and the stator coils 16 set on the lower retaining group 22B correspond to, for example, the stator coil that is set first and the stator coil that is set last when manually forming the stator coils 16. A section at which the second retaining members 22 are connected to each other corresponds to a section where the stator coil 16 that is set first overlaps the stator coil 16 that is set last. For example, in a case where the stator coils 16 are set on an annular setting jig that cannot be divided, it is impossible to arrange the stator coil 16 that is set last below the stator coil 16 that is set first.

However, in the first embodiment, part of the setting jig 20 can be divided into the upper retaining group 22A and the lower retaining group 22B. As shown in FIG. 2, after setting the stator coils 16 on the divided upper retaining group 22A and the lower retaining group 22B, the upper retaining group 22A is connected to the lower retaining group 22B. As a result, the stator coils 16 that correspond to the connected section of the upper retaining group 22A and the lower retaining group 22B overlap one another to form a spiral shape. That is, the stator coil 16 that is set last is arranged below the stator coil 16 that is set first.

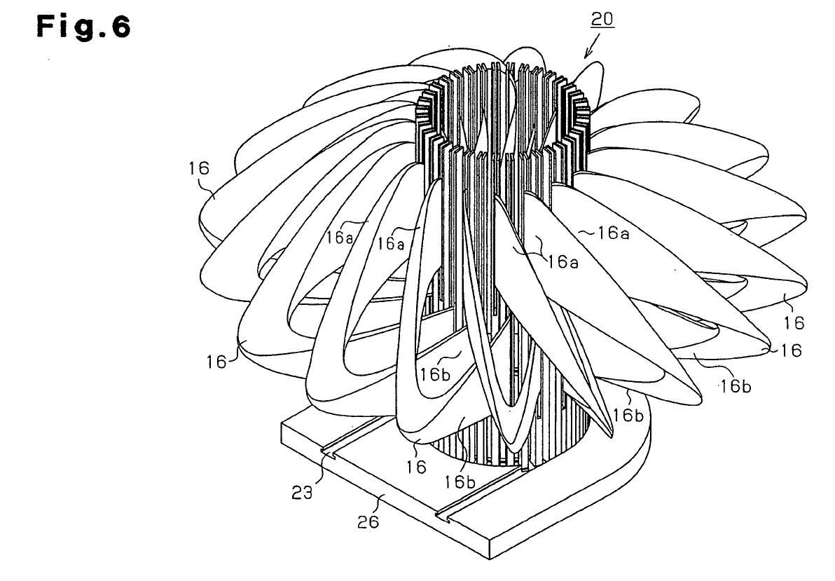

FIG. 6 shows a state where all the first retaining members 21 and the second retaining members 22 are arranged in an annular shape. According to the method of the first embodiment, all the stator coils 16 are formed in the same manner as shown in FIG. 6, and are uniformly arranged to overlap one another in a spiral shape. As shown in FIG. 7, the diameter of the setting jig 20 in a cylindrical state is equal to the diameter of the inserting blade 27.

All the stator coils 16 set on the setting jig 20 as shown in FIG. 6 are set on the inserting blade 27 while maintaining the state of FIG. 6. That is, all the stator coils 16 are moved to the inserting blade 27 while maintaining the state where there is a phase difference between the first section 16a and the second section 16b of each stator coil 16, and the stator coils 16 overlap one another to form a spiral shape. FIG. 7 shows midstream of a moving process in which all the stator coils 16 formed on the setting jig 20 are moved from the setting jig 20 to the inserting blade 27. The cylindrical inserting blade 27 has fifth slits S5, which extend in the longitudinal direction. The fifth slits S5 are formed on the circumferential surface at equal intervals. The stator coils 16 are inserted in and supported by the fifth slits S5. The arrangement pitch of the fifth slits S5 correlates with the arrangement pitch of the teeth 12 of the stator core 11. The arrangement pitch of the slits S1 to S4 correlates with the arrangement pitch of the teeth 12 in a state where the slits S1 to S4 are arranged in an annular shape as shown in FIG. 6. When setting the stator coils 16 on the inserting blade 27, the inserting blade 27 is put on the setting jig 20 such that the opening portions of the slits S1 to S4 are aligned with the opening portions of the fifth slits S5. Thus, the stator coils 16 inserted in the slits S1 to S4 of the setting jig 20 are movable to the fifth slits S5 of the inserting blade 27.

The first section 16a of each stator coil 16 is moved from the setting jig 20 to the inserting blade 27 by moving upward in FIG. 7. Subsequently, the second section 16b of each stator coil 16 is moved from the setting jig 20 to the inserting blade 27 in the same manner. In a state where all the first sections 16A are located on the inserting blade 27 and all the second sections 16b are located on the setting jig 20, the inserting blade 27 may be rotated with respect to the setting jig 20 by half the arrangement pitch of the teeth 12. In this case, the second section 16b of each stator coil 16 is inserted in the fifth slit S5 in which the first section 16a of another stator coil 16 is inserted.

The inserting blade 27, on which the stator coils 16 are set so as to overlap one another to form a spiral shape, is mounted on an inserter (not shown). The inserter inserts all the stator coils 16 to the stator core 11. That is, while maintaining the state formed on the setting jig 20 where the stator coils 16 overlap one another to form a spiral shape, all the stator coils 16 are moved from the setting jig 20 to the inserting blade 27, and further from the inserting blade 27 to the stator core 11. The inserter extrudes all the stator coils 16 from the inserting blade 27 to the stator core 11 by a mechanical configuration or an electrical configuration.

The above mentioned first embodiment has the following advantages.

(1) The stator coils 16 are set on the setting jig 20 in an inclined state such that at least part of the stator coils 16 overlap one another. The setting jig 20 has the main retaining group 21A, and the upper retaining group 22A and the lower retaining group 22B, which sandwich the main retaining group 21A. When the stator coils 16 are set on the upper retaining group 22A and the lower retaining group 22B, the upper retaining group 22A and the lower retaining group 22B are separate from each other.

The second retaining members 22 of the upper retaining group 22A are connected to the second retaining members 22 of the lower retaining group 22B in a state where all the stator coils 16 are set so that all the first retaining members 21 and all the second retaining members 22 are arranged in an annular shape. As a result, the stator coils 16 set on the upper retaining group 22A overlap the stator coils 16 set on the lower retaining group 22B. That is, the stator coils 16 located on both ends of the first base 24 in FIG. 4 overlap each other at a connecting section between the upper retaining group 22A and the lower retaining group 22B. As a result, all the stator coils 16 are uniformly arranged in a state where the stator coils 16 overlap one another to form a spiral shape. All the stator coils 16, which are formed into a spiral shape by the setting jig 20, are set on the inserting blade 27. As a result, when mounting the stator coils 16 on the stator core 11 in a state where the stator coils 16 overlap one another to form a spiral shape using the inserter, all the stator coils 16 are uniformly arranged.

(2) Uniformly arranging all the stator coils 16 suppresses reduction in the efficiency of the rotating electrical machine. Furthermore, since the stator coils 16 are uniformly arranged on the integrated stator core 11 instead of a stator core in which divided cores are combined, reduction in the efficiency of the rotating electrical machine is further suppressed.

(3) The first retaining members 21 and the second retaining members 22 are selectively separated from one another. Therefore, the first retaining members 21 and the second retaining members 22 can be arranged such that the stator coils 16 are easily set. Thus, the stator coils 16 are set on the first retaining members 21 and the second retaining members 22 more efficiently.

(4) When setting the stator coils 16, the first retaining members 21 and the second retaining members 22 are arranged on the first base 24 along the same straight line. Thus, for example, as compared to a case where the first retaining members 21 and the second retaining members 22 are arranged along a curved line, the stator coils 16 are easily set on the first retaining members 21 and the second retaining members 22.

(5) When setting the stator coils 16, the first retaining members 21 and the second retaining members 22 are arranged in the straight groove 23 of the first base 24. Thus, the first retaining members 21 and the second retaining members 22 are easily arranged on the same line. Furthermore, since the first retaining members 21 and the second retaining members 22, on which the stator coils 16 are set, are moved from the straight groove 23 to the annular shape forming groove 25, the stator coils 16 are easily moved to be arranged in an annular shape.

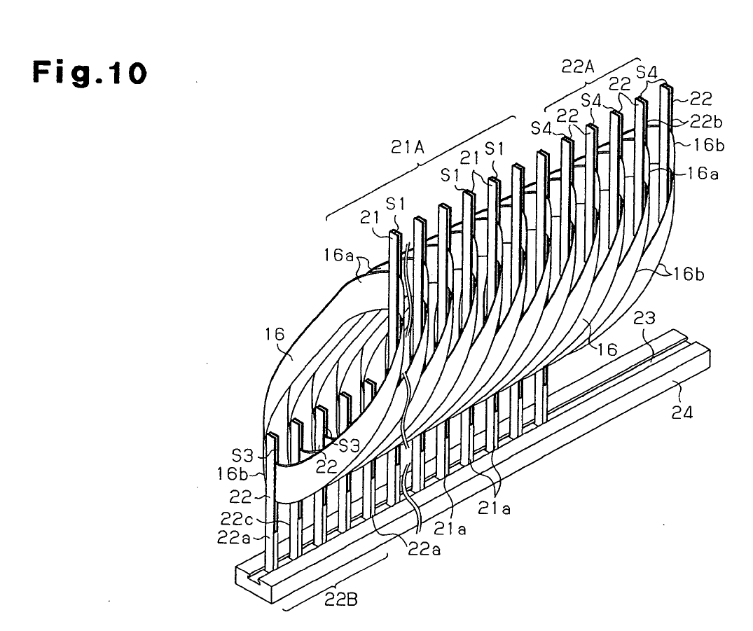

A second embodiment of the present invention will now be described with reference to FIG. 10. Like or the same reference numerals are given to those components that are like or the same as the corresponding components of the first embodiment, and detailed explanations are omitted.

FIG. 10 shows a state where all the stator coils 16 are set on the setting jig 20 of the second embodiment. Two stator coils 16 are inserted in each slot 14 of the stator core 11. The main retaining group 21A of the second embodiment includes only the first long bars 21a, each of which has the first slit S1, and the second long bars 21b are omitted. The upper retaining group 22A of the second embodiment includes only the second short bars 22b, each of which has the fourth slit S4, and the lower retaining group 22B includes only the first short bars 22a, each of which has the third slit S3. That is, the first short bars 22a are omitted from the upper retaining group 22A, and the third short bars 22c are omitted from the lower retaining group 22B. Connecting the second retaining members 22 of the upper retaining group 22A to the second retaining members 22 of the lower retaining group 22B forms the first retaining members 21.

The first retaining members 21 and the second retaining members 22 of the second embodiment are arranged on the first base 24 in the same manner as the first embodiment. The first section 16a of each stator coil 16 is inserted in one of the retaining members 21, 22, and the second section 16b of the stator coil 16 is inserted in one of the retaining members 21, 22 separate from the first section 16a such that a predetermined number of (four in FIG. 10) the retaining members 21, 22 are located in between. The number of the second retaining members 22 of the upper retaining group 22A and the number of the second retaining members 22 of the lower retaining group 22B are determined in accordance with the number of the teeth 12 over which the stator coil 16 will extend. In the case of FIG. 10, the upper retaining group 22A and the lower retaining group 22B are each configured by five second retaining members 22.

After setting all the stator coils 16 on the setting jig 20, the second retaining members 22 of the upper retaining group 22A are connected to the second retaining members 22 of the lower retaining group 22B. Thus, all the first retaining members 21 and the second retaining members 22 are arranged along an annular line. Therefore, as in the first embodiment, all the stator coils 16 of the second embodiment are also formed in the same manner and are uniformly arranged in a state where the stator coils 16 overlap one another to form a spiral shape. All the stator coils 16 are then moved from the setting jig 20 to the inserting blade 27. The second embodiment has the same advantages as the first embodiment.

The above embodiments may be modified as follows.

In the above embodiments, when setting the stator coils 16 on the setting jig 20, the distance between one of the retaining members 21, 22 in which the first section 16a of one of the stator coils 16 is inserted and one of the retaining members 21, 22 in which the second section 16b of this stator coil 16 is inserted may be changed. The distance is determined in accordance with the specification of the rotating electrical machine as described above.

In the above embodiments, the number of the stator coils 16 set on the setting jig 20 may be varied. The number of the stator coils 16 set on the setting jig 20 is also determined in accordance with the specification of the rotating electrical machine.

In the above embodiments, when setting the stator coils 16, the retaining members 21, 22 need not be arranged on the straight line, but may be arranged on an arcuate line. The retaining members 21, 22 may be arranged in any form as long as the upper retaining group 22A is separated from the lower retaining group 22B when the stator coils 16 are set on the retaining members 21, 22.

In the above embodiments, the retaining members 21, 22 may be connected to one another by a connecting mechanism. However, the second retaining members 22 of the upper retaining group 22A should not be connected to the second retaining members 22 of the lower retaining group 228.

In the above embodiments, the depth of the straight groove 23 of the first base 24 may be increased such that the side surfaces of the straight groove 23 clamp and support the retaining members 21, 22 inserted in the straight groove 23.

In the above embodiments, the length of the second retaining members 22 of the upper retaining group 22A may differ from the length of the second retaining members 22 of the lower retaining group 22B. The length may be varied as long as the length when the second retaining members 22 of the upper retaining group 22A are connected to the second retaining members 22 of the lower retaining group 22B is equal to the length of the first retaining members 21.

In the above embodiments, the inserting blade 27 may also serve as the setting jig 20. In this case, the first retaining members 21 and the second retaining members 22 are blade components. That is, the first retaining members 21 and the second retaining members 22 are blade members configuring the inserting blade 27. In this case, all the stator coils 16 are formed on the inserting blade 27. This simplifies the procedure.

In the first embodiment, all the first retaining members 21 of the main retaining group 21A may be the first long bars 21a, each of which has the first slit S1.

In the above embodiments, the diameter of the inserting blade 27 may differ from the diameter of the setting jig 20 in the cylindrical state. That is, the inserting blade 27 may be arranged radially outward of the setting jig 20. In contrast, the inserting blade 27 may be arranged radially inward of the setting jig 20.

1. A method for setting a plurality of stator coils on an inserting blade before mounting the stator coils on a stator core using the inserting blade such that the stator coils overlap one another to form a spiral shape, the method comprising:
preparing a coil holder, the coil holder including a first retaining group and a pair of second retaining groups, which sandwich the first retaining group, the first retaining group including a plurality of rod-like first coil retainers, the pair of second retaining groups each including the same number of second coil retainers, the length of the second coil retainers differ from the length of the first coil retainers, the first coil retainers and the second coil retainers are arranged on a same line, and the pair of second retaining groups are displaced from each other in the longitudinal direction of the second coil retainers;
sequentially setting the stator coils on the coil holder along a predetermined direction, each stator coil being set on two of the coil retainers that are separate from each other so as to sandwich a predetermined number of the coil retainers, the stator coils being inclined with respect to the coil retainers, and at least part of the stator coils overlap one another;
connecting the second coil retainers of one of the second retaining group to the second coil retainers of the other second retaining group with respect to the longitudinal direction of the second coil retainers, while arranging the coil retainers in an annular shape at equal intervals; and
setting the stator coils on the inserting blade.

2. The method according to claim 1, wherein the coil retainers are selectively separated from one another.

3. The method according to claim 1, wherein, when setting the stator coils on the coil retainers, the coil retainers are arranged on a same straight line.

4. The method according to claim 1, wherein the coil retainers are arranged on a rail, the rail supports the coil retainers, and guides movement of the coil retainers.

5. The method according to claim 1,
wherein the coil retainers also serve as the inserting blade, and
wherein the coil retainers are blade components configuring the inserting blade.

6. A method for manufacturing a rotating electrical machine, which includes a stator core on which a plurality of stator coils are mounted such that the stator coils overlap one another to form a spiral shape as a whole, the method comprising:
setting the stator coils on an inserting blade by the setting method according to claim 1; and
inserting the stator coils set on the inserting blade in slots formed in the stator core.
